(19) United States
(12) Patent Application Publication
(10) Pub. No.: US 2023/0034702 A1
(43) Pub. Date: Feb. 2, 2023

(54) DELIVERY VEHICLE HAVING A PACKAGE POSITIONING SYSTEM

(71) Applicant: Lear Corporation, Southfield, MI (US)

(72) Inventors: Frank Orsini, Oakland Township, MI (US); Lea Thomas Smith, Severna Park, MD (US); Dave Anderson, Orchard Lake, MI (US); Dhananjay Ingale, Pune (IN); Jochen Kohlhofer, Altfraunhofen (DE)

(73) Assignee: Lear Corporation, Southfield, MI (US)

(21) Appl. No.: 17/848,517

(22) Filed: Jul. 11, 2022

(30) Foreign Application Priority Data
Jul. 28, 2021 (DE) 10 2021 119 586.1

(51) Int. Cl. B60P 1/00

(52) U.S. Cl. CPC B60P 1/006

(57) ABSTRACT

A delivery vehicle having a cargo area and a package positioning system that includes a moveable panel. The moveable panel may move a package in the cargo area. In at least one configuration, the panel may be mounted to first and second cassettes that are moveably disposed in first and second rails.

### TECHNICAL FIELD

This relates to a delivery vehicle, such as a delivery van or delivery truck, having a package positioning system that may include a moveable panel that may be configured to move one or more packages.

### BACKGROUND

A package delivery vehicle having a stationary panel and shelving units is disclosed in U.S. Pat. No. 9,950,862.

### SUMMARY

In at least one configuration a delivery vehicle is provided. The delivery vehicle may include a cargo area and a moveable panel. The cargo area is at least partially defined by a floor and a roof. The moveable panel is disposed in the cargo area and extends between the floor and the roof. The moveable panel is configured to move a package in the cargo area.

In at least one configuration a delivery vehicle is provided. The delivery vehicle may include a cargo area, first and second rails, first and second cassettes, and a panel. The cargo area is at least partially defined by a floor, a roof, and a side wall that extends from the floor to the roof. The first and second rails are separated from each other and are mounted to the side wall. The first and second rails each define a cassette groove. The first cassette is moveably disposed in the cassette groove of the first rail. The second cassette is moveably disposed in the cassette groove of the second rail. The panel is mounted to the first cassette and the second cassette and is engageable with a package that is disposed in the cargo area.

In at least one configuration, a method of assembling a delivery vehicle is provided. The method may include providing a body-in-white vehicle body that a floor, a roof, and a side wall that is joined to the floor and the roof. First and second rails may be part of the side wall of the body-in-white. The first and second rails may be separated from each other and may each define a cassette groove.

### BRIEF DESCRIPTION OF THE DRAWINGS

FIGS. 1-3 are fragmentary views of an example of a delivery vehicle having a package positioning system that includes a moveable panel and illustrates the moveable panel in various positions.

FIGS. 4 and 5 are simplified plan views of the delivery vehicle that show the moveable panel in the positions shown in FIGS. 1 and 3.

FIG. 6 is a plan view of the delivery vehicle with multiple moveable panels.

FIG. 7 is a plan view of the delivery vehicle of FIG. 6 showing independent movement of the moveable panels.

FIG. 8 is a fragmentary perspective view of a portion of a delivery vehicle having another configuration of a package positioning system.

FIG. 9 is an enlarged view of a portion of the package positioning system of FIG. 8.

FIG. 10 is a magnified view of a portion of the package positioning system of FIG. 8 that includes a cross section of a rail.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

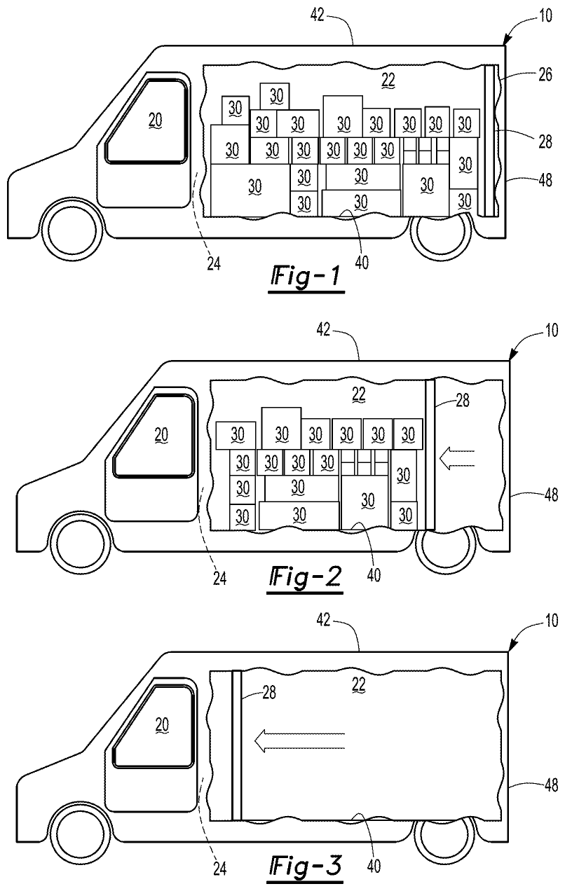

Referring to FIG. 1, an example of a delivery vehicle 10 is shown. The delivery vehicle 10 may be a vehicle of any suitable type, such as a land vehicle like a truck or van.

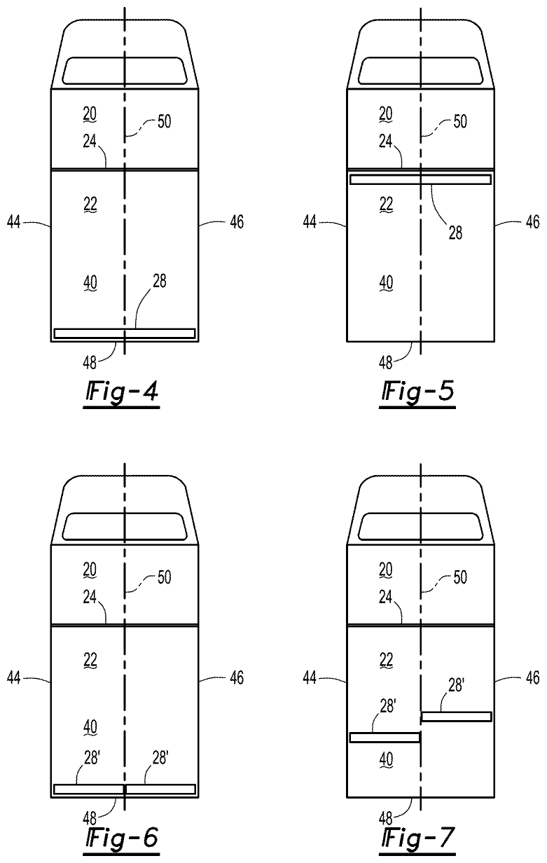

In at least one configuration and as is best shown with reference to FIGS. 1 and 4, the delivery vehicle 10 may include a passenger compartment 20, a cargo area 22, and a bulkhead 24. In addition, the delivery vehicle 10 may include a package positioning system 26 having at least one moveable panel 28.

The passenger compartment 20 may be disposed near the front or front end of the delivery vehicle 10, which is located to the left from the perspective shown in FIGS. 1-3. The passenger compartment 20 may have a driver's seat for receiving a driver of the delivery vehicle 10.

The cargo area 22 may be disposed behind the passenger compartment 20. The cargo area 22 may receive one or more packages 30 that are to be delivered by the delivery vehicle 10. For clarity, only some of the packages 30 are labeled in FIG. 1. The cargo area 22 may be defined by or bounded by multiple sides of the delivery vehicle 10, such as a floor 40, a roof 42, a first side wall 44, a second side wall 46, and a rear wall 48, which may separate the cargo area 22 from the surrounding environment outside the delivery vehicle 10. In addition, the cargo area 22 may be further bounded by the bulkhead 24.

The floor 40, which may also be referred to as a floor pan, may define the bottom of the cargo area 22. The floor 40 may be disposed on a frame or chassis of the delivery vehicle 10 and may support one or more packages 30.

The roof 42 may define the top of the cargo area 22. The roof 42 may be disposed above the floor 40 and may be spaced apart from the floor 40.

The first side wall 44 may extend in a generally vertical direction from the floor 40 to the roof 42. In addition, the first side wall 44 may extend in a longitudinal direction between the passenger compartment 20 and the rear wall 48. For instance, the first side wall 44 or a portion thereof may extend substantially parallel to a longitudinal center plane 50 of the delivery vehicle 10, which is best shown in FIG. 4. The term “substantially parallel” as used herein means the same as or very close to parallel and includes features or axes that are within ±2° of being parallel each other. The longitudinal center plane 50 may be disposed proximate the center of the delivery vehicle 10 and may extend in a longitudinal direction, which may be a direction that extends between the front and the rear or rear end of the delivery vehicle 10, which is located to the right from the perspective shown in FIGS. 1-3 and to the bottom from the perspective shown in FIGS. 4-7.

The second side wall 46 may be disposed opposite the first side wall 44 and may be spaced apart from the first side wall 44. The second side wall 46 may extend in a generally vertical direction from the floor 40 to the roof 42. In addition, the second side wall 46 may extend in a longitudinal direction between the passenger compartment 20 and the rear wall 48. The second side wall 46 or portion thereof may extend substantially parallel to the longitudinal center plane 50.

It is contemplated that the first side wall 44, the second side wall 46, or both may include one or more side doors that may facilitate access to the cargo area 22.

The rear wall 48 may be disposed proximate the rear of the delivery vehicle 10. The rear wall 48 may extend in a generally vertical direction from the floor 40 to the roof 42. In addition, the rear wall 48 may extend in a lateral direction from the first side wall 44 to the second side wall 46. In at least one configuration, the rear wall 48 may include one or more rear doors that may facilitate access to the cargo area 22. The rear wall 48 may be spaced apart from and may be disposed opposite the bulkhead 24.

The bulkhead 24 may separate the passenger compartment 20 from the cargo area 22. As such, the bulkhead 24 may be disposed rearward of the passenger compartment 20 and may be disposed at the front of the cargo area 22. The bulkhead 24 may be a fixed bulkhead that may be stationary. The bulkhead 24 may extend in a generally vertical direction between the floor 40 and the roof 42. For instance, the bulkhead 24 may extend from the floor 40 toward or to the roof 42. In addition, the bulkhead 24 may extend in a lateral direction between the first side wall 44 and the second side wall 46. For example, the bulkhead 24 may extend from the first side wall 44 to the second side wall 46. The bulkhead 24 may be disposed substantially perpendicular to the longitudinal center plane 50. The term “substantially perpendicular” is used herein to designate features or axes that are the same as or very close to perpendicular and includes features that are within ±2° of being perpendicular each other.

In at least one configuration, the bulkhead 24 may include one or more openings. An opening may be sized to permit a package 30 to fit through the opening. Alternatively or in addition, an opening may be sized to permit the driver to pass through the opening to move between the passenger compartment 20 and the cargo area 22. It is also contemplated that the bulkhead 24 may be omitted in one or more configurations.

One or more moveable panels 28 or moveable bulkheads may be disposed in the cargo area 22. A moveable panel 28 may be configured to move one or more packages 30 in the cargo area 22 as will be discussed in more detail below. In at least one configuration, the moveable panel 28 may extend in a generally vertical direction between the floor 40 and the roof 42. In addition, a moveable panel 28 may extend in a lateral direction between the first side wall 44 and the second side wall 46. In at least one configuration, the moveable panel 28 may be disposed substantially parallel to the bulkhead 24. The moveable panel 28 may be made of any suitable material or materials. For instance, a moveable panel may be made of a metal alloy, a polymeric material, carbon fiber, or combinations thereof. It is contemplated that a moveable panel 28 or a portion thereof may be made of a transparent or semi-transparent material that may permit rearward visibility from the passenger compartment 20 through the moveable panel 28.

Referring to FIGS. 4 and 5, a schematic representation of a delivery vehicle 10 is shown that is provided with a single moveable panel 28. In such a configuration, the moveable panel 28 may extend from the first side wall 44 to the second side wall 46 or may be disposed sufficiently close to the first side wall 44 and the second side wall 46 to prevent a package 30 from passing between a lateral end of the moveable panel 28 and an adjacent side wall. For clarity, packages 30 are not depicted in FIGS. 4 and 5. The moveable panel 28 may be moveable in a longitudinal direction of the delivery vehicle 10, or in a direction that extends along the longitudinal center plane 50 or substantially parallel to the longitudinal center plane 50. For instance, the moveable panel 28 may roll along or be guided in tracks in the floor 40, the roof 42, the first side wall 44, the second side wall 46, or combinations thereof. The distance of travel of the moveable panel 28 in a longitudinal direction may be bounded by the bulkhead 24 and the rear wall 48. In FIG. 4, the moveable panel 28 is shown in a rearward position that may be disposed proximate the rear wall 48 of the delivery vehicle 10. In FIG. 5, the moveable panel 28 is shown in a frontward position that may be disposed proximate the bulkhead 24.

The moveable panel 28 may be configured to move packages toward the bulkhead 24, toward the rear wall 48, or both. In the configuration shown in FIGS. 1-3, a configuration is illustrated in which the moveable panel 28 is configured to move one or more packages 30 toward the front of the delivery vehicle 10 and toward the passenger compartment 20.

In FIG. 1 the moveable panel 28 is shown in the rearward position. Packages 30 may be loaded into the cargo area 22 to the front with respect to the moveable panel 28. It is contemplated that packages 30 may be loaded in a predetermined arrangement that may be based on a package delivery sequence. For instance, packages 30 that may be delivered first or earliest in the delivery sequence may be located furthest from the moveable panel 28. Conversely, packages 30 that may be delivered last or toward the end of the delivery sequence may be located closer or closest to the moveable panel 28. Packages 30 may be stacked vertically from the floor 40 toward the roof 42. Packages 30 may also be arranged horizontally between the first side wall 44 and the second side wall 46. Optionally, a longitudinal aisle through the cargo area 22 may be omitted in one or more configurations, thereby allowing a larger volume of packages to be accommodated or held in the cargo area 22.

In FIG. 2, the moveable panel 28 is shown in an example of an intermediate position in which the moveable panel 28 may be disposed between the rearward position of FIG. 1 and the frontward position of FIG. 3. The moveable panel 28 may be moved manually or automatically from the rearward position to the intermediate position to push one or more packages 30 toward the passenger compartment 20, thereby positioning a package 30 closer to the driver to facilitate access and reduce package retrieval time. The moveable panel 28 may be actuated or advanced after packages 30 are delivered and space becomes available near the bulkhead 24 that may allow the moveable panel 28 to be advanced without damaging one or more packages 30. The moveable panel 28 may be actuated manually or automatically. For instance, the moveable panel 28 may be actuated based on a driver input, such as a switch. Alternatively, the moveable panel 28 may be actuated automatically, such as based on inputs from one or more sensors that may detect whether space is available between the bulkhead 24 and packages 30 located closest to the bulkhead 24.

Referring to FIG. 3, the moveable panel 28 is shown in the frontward position. The moveable panel 28 may be located in the frontward position when no packages remain in the cargo area 22. The moveable panel 28 may be returned to the rearward position manually or automatically to permit the cargo area 22 to be refilled. The moveable panel 28 may be returned to the rearward position after the delivery vehicle 10 returns to a storage facility or warehouse.

It is also contemplated that the moveable panel 28 may be configured to move one or more packages 30 toward the rear of the delivery vehicle 10, or in the opposite manner that is shown in FIGS. 1-3. In such a configuration, the moveable panel 28 may be disposed in the frontward position proximate the bulkhead 24 when packages 30 are loaded into the cargo area 22. The moveable panel 28 may then move toward the rear of the delivery vehicle 10 to actuate packages 30 toward the rear wall 48, thereby positioning a package 30 closer to the rear wall 48 to facilitate access through a door or opening, which may help reduce package retrieval time as compared to situations in which the driver needs to search for packages and/or enter the cargo area 22 through the rear wall 48. The moveable panel 28 may be disposed in the rearward position or adjacent to the rear wall 48 when no packages remain in the cargo area 22.

Providing a moveable panel 28 as described above may be beneficial in a delivery vehicle 10 having a thermally controlled cargo area 22. A thermally controlled cargo area 22 may have a heating or cooling system that may be configured to keep the cargo area 22 at a predetermined temperature range. For instance, the cargo area 22 may be configured to accommodate refrigerated cargo or frozen cargo. The moveable panel 28 may be configured to seal against adjacent surfaces, such as the floor 40, the roof 42, the first side wall 44, the second side wall 46, or combinations thereof to help keep temperature-controlled air in the portion of the cargo area 22 that receives packages 30. The moveable panel 28 may be moved to reduce the volume of the thermally controlled cargo area 22, which in turn may help reduce energy consumption and associated costs as compared to a configuration in which the volume of the cargo area 22 remains constant.

Referring to FIGS. 6 and 7, a schematic representation of a delivery vehicle 10 is shown that is provided with multiple moveable panels. For convenience in reference, these moveable panels are referenced with reference number 28′. Two moveable panels 28′ are shown; however, it is contemplated that a greater number of moveable panels 28′ may be provided. In the configuration shown, a moveable panel 28′ may extend from or may be disposed adjacent to a single side wall. For example, a first moveable panel 28′ may be disposed proximate the first side wall 44 while a second moveable panel 28′ may be disposed proximate the second side wall 46. For instance, the first moveable panel 28′ may be disposed sufficiently close to the first side wall 44 to prevent a package 30 from passing between an end of the first moveable panel 28′ and the first side wall 44 while the second moveable panel 28′ may be disposed sufficiently close to the second side wall 46 to prevent a package 30 from passing between an end of the second moveable panel 28′ and the second side wall 46. For clarity, packages 30 are not depicted in FIGS. 6 and 7. The first and second moveable panels 28′, 28′ may extend away from an adjacent side wall toward the longitudinal center plane 50. Moreover, an end of the first moveable panel 28′ may be disposed adjacent to or may engage an end of the second moveable panel 28′ when the first and second moveable panels 28′, 28′ are aligned with each other, such as is shown in FIG. 6.

The moveable panels 28′, 28′ may be independently moveable with respect to each other. For instance, first and second moveable panels 28′, 28′ may be independently moveable in the longitudinal direction or in a direction that extends along the longitudinal center plane 50 or substantially parallel to the longitudinal center plane 50. The distance of travel of a moveable panel 28′ in a longitudinal direction may be bounded by the bulkhead 24 and the rear wall 48.

In FIG. 6, the first and second moveable panels 28′, 28′ are aligned with each other and are shown in a rearward position that may be disposed proximate the rear wall 48 of the delivery vehicle 10.

In FIG. 7, the first and second moveable panels 28′, 28′ are shown in examples of intermediate positions in which the first and second moveable panels 28′, 28′ are moved forward and are disposed closer to the bulkhead 24. In FIG. 7, the first and second moveable panels 28′, 28′ are moved toward the front of the delivery vehicle 10 by different distances.

Providing multiple independently moveable panels may allow packages 30 to be moved in a desired direction more frequently than in a configuration having a single moveable panel. For instance, a moveable panel 28′ may be actuated or advanced after packages 30 are removed and space becomes available in front of a single moveable panel 28′ or across a shorter portion of the lateral width of the delivery vehicle 10 as compared to a configuration having a single moveable panel 28. As previously discussed, it is contemplated that the moveable panels 28′ may be configured to move one or more packages 30 toward the rear of the delivery vehicle 10 rather than toward the front of the delivery vehicle 10, or in the opposite manner that is shown in FIGS. 6 and 7. Providing one or more moveable panels may also allow free space around the packages 30 to be reduced, which may help inhibit movement of the packages 30 during transport and potential damage.

It is also contemplated that in any of the configurations previously discussed a center aisle may be maintained to facilitate driver access to help retrieve packages 30 that may be out of sequence or may have unusual configurations or excessive weight.

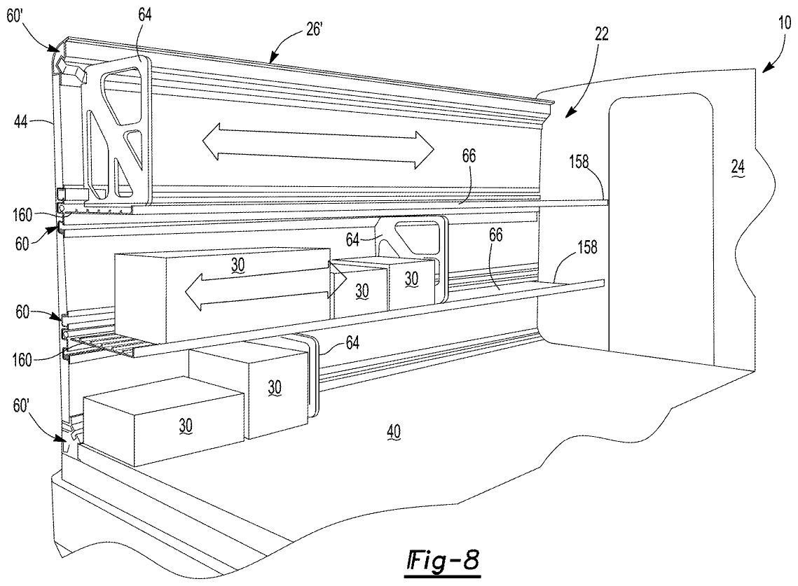

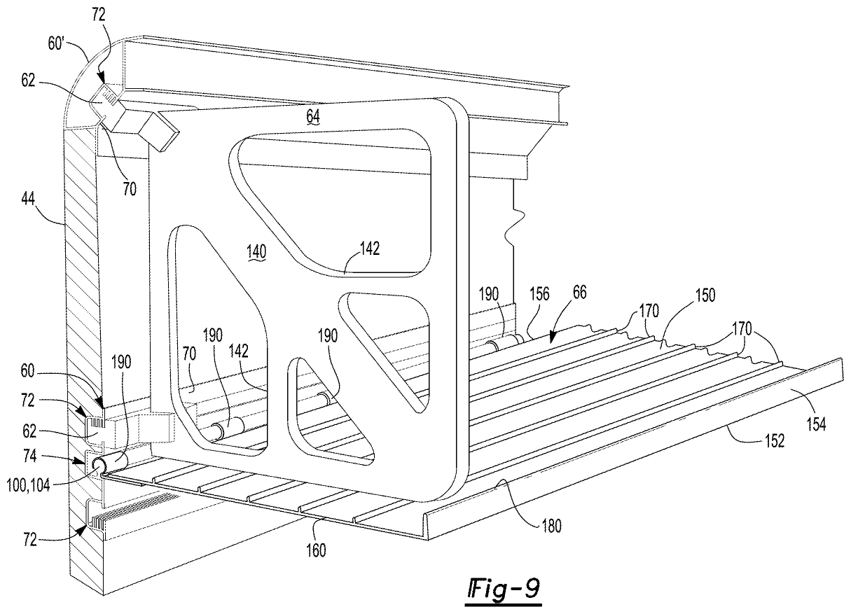

Referring to FIGS. 8-10, a delivery vehicle 10 that has another configuration of a package positioning system 26′ is shown. In FIGS. 8 and 9, only a portion of the delivery vehicle 10 is shown with at least a portion of the floor 40, roof 42, second side wall 46, and rear wall 48 removed to better show the package positioning system 26′. The package positioning system 26′ is shown extending from the first side wall 44; however, it is to be understood that the package positioning system 26′ may also extend from another wall, such as the second side wall 46. The package positioning system 26′ may include one or more rails 60, 60′, one or more cassettes 62, and one or more panels 64. One or more shelves 66 may also be provided.

One or more rails 60, 60′ may be mounted to a wall of the delivery vehicle 10, such as the first side wall 44, the second side wall 46, or both. It is also contemplated that a rail 60, 60′ may be mounted to the bulkhead 24, the floor 40, the roof 42, the rear wall 48, or combinations thereof in other configurations. In the configuration shown, four rails are depicted; however, it is contemplated that a greater or lesser number of rails 60, 60′ may be provided. As is best shown with reference to FIG. 9, each rail 60, 60′ may have a front face 70 and may define at least one cassette groove 72.

The front face 70 may face toward the cargo area 22. In at least one configuration, the front face may be substantially planar and may be separated or segmented by a cassette groove 72.

The cassette groove 72 may be configured as a recess that extends away from the cargo area 22 and the front face 70. The cassette groove 72 may extend the entire longitudinal length of the rail 60, 60′. As such, a rail 60, 60′ may have a substantially constant cross section along its length. The cassette groove 72 may receive and may permit movement of at least one cassette 62 as will be discussed in more detail below. Positioning a rail 60, 60′ along vertically-extending walls of the delivery vehicle 10 may help reduce or prevent contaminants such as dust, dirt, or small loose objects from collecting in a cassette groove 72 that may interfere with the free movement of a cassette 62 that is slidable along the cassette groove 72.

Different types of rails or rails having different configurations may be provided with the delivery vehicle 10. Different types of rails may be categorized or identified by the number of cassette grooves 72 that are provided with the rail. For convenience in reference, reference number 60 is used to refer to a rail that has multiple cassette grooves 72, such as the two middle rails in FIG. 8 that are spaced apart from the floor 40 and the roof 42. Reference number 60′ is used to refer to a rail that has a single cassette groove 72, such as the rail 60′ that is disposed closest to the floor 40 and the rail 60′ that is disposed closest to the roof 42.

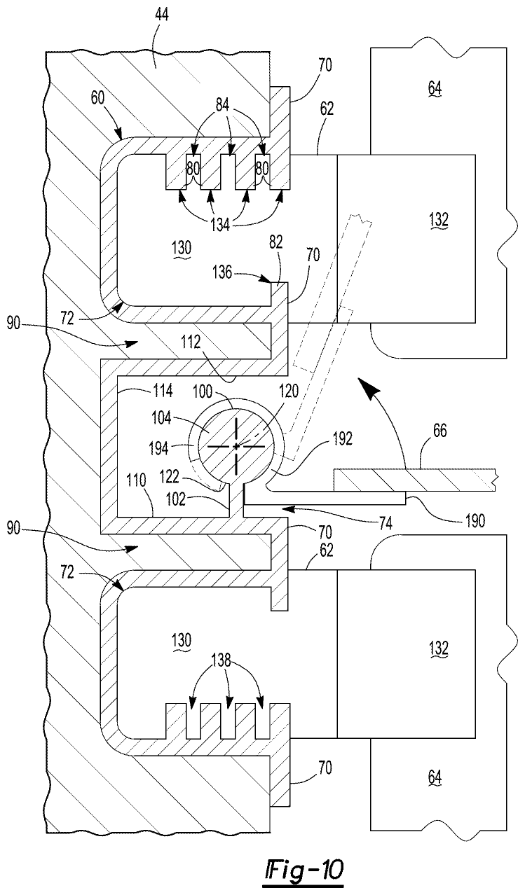

Referring to FIG. 10, a cross section of an example of a rail 60 that has multiple cassette grooves 72 is shown. In the configuration shown, two cassette grooves 72 are illustrated that are disposed on opposite sides of a shelf groove 74. The cassette grooves 72 are illustrated as mirror images of each other; however, it is contemplated that the cassette grooves 72 may be provided without mirror symmetry and may have cross sections with identical orientations. In the configuration shown, the cassette groove 72 may include a first set of ribs 80 and a guide rib 82.

The first set of ribs 80 may extend into the cassette groove 72 from a side of the rail 60 that defines the cassette groove 72. In the configuration shown, the ribs 80 extend from a side of the rail 60 that is disposed furthest from the shelf groove 74 toward the shelf groove 74. Four ribs 80 is illustrated; however it is contemplated that the first set of ribs 80 may include a greater or lesser number of ribs. The ribs 80 may be spaced apart from an opposite side of the rail 60, such as a side of the rail 60 that is disposed closest to the shelf groove 74. The ribs 80 may be spaced apart from each other such that a gap 84 is provided between two adjacent ribs 80. The ribs 80 may be linear and may help position and inhibit rotation of a cassette 62 that is received in the cassette groove 72 as will be discussed in more detail below.

The guide rib 82 may be spaced apart from the set of ribs 80. In addition, the guide rib 82 may be disposed opposite the first set of ribs 80. For instance, the guide rib 82 may extend toward a member of the first set of ribs 80. In the configuration shown, the guide rib 82 extends away from the shelf groove 74 and is disposed adjacent to the front face 70 of the rail 60. The guide rib 82 may be linear and may help position and inhibit rotation of a cassette 62 that is received in the cassette groove 72.

The shelf groove 74 may be disposed proximate a cassette groove 72. In the configuration shown, the shelf groove 74 is positioned vertically between the upper cassette groove 72 and the lower cassette groove 72 and is spaced apart from the upper cassette groove 72 and the lower cassette groove 72. In such a configuration, a cavity 90 may be provided between the shelf groove 74 and an adjacent cassette groove 72. The cavity 90 may receive a portion of a wall of the delivery vehicle 10, such as a side wall. It is also contemplated that the cavity 90 may be omitted and that the shelf groove 74 and a cassette groove 72 may share a common wall that extends away from the front face 70. Like the cassette groove 72, the shelf groove 74 may be configured as a recess that extends away from the cargo area 22 and the front face 70. The shelf groove 74 may extend the entire longitudinal length of the rail 60. In at least one configuration, a shelf mounting protrusion 100 may be provided with the shelf groove 74.

The shelf mounting protrusion 100 may facilitate mounting of a shelf 66. The shelf mounting protrusion 100 may be located inside the shelf groove 74. The shelf mounting protrusion 100 may have any suitable configuration. In the configuration shown, the shelf mounting protrusion 100 includes a stem 102 and an enlarged bead 104.

The stem 102 may be located inside the shelf groove 74. The stem 102 may extend from a side or wall of the rail 60 that defines the shelf groove 74. In the configuration shown, the stem 102 extends from a bottom side 110 toward a top side 112 that is disposed opposite the bottom side 110. The bottom side 110 and the top side 112 may be disposed substantially parallel to each other and may extend from the front face 70 to a back side 114 that may extend from the bottom side 110 to the top side 112. The stem 102 may be spaced apart from the top side 112 and the back side 114. In addition, the stem 102 may be disposed closer to the front face 70 than to the back side 114. Such positioning may position the enlarged bead 104 closer to the front face 70 which in turn may accommodate a larger range of rotation of a shelf 66.

The enlarged bead 104 may extend from an end of the stem 102. The enlarged bead 104 may be at least partially disposed inside the shelf groove 74 and may be spaced apart from the bottom side 110, the top side 112, and the back side 114. The enlarged bead 104 may extend outwardly from the stem 102 in multiple directions and may have a larger cross-sectional area than the stem 102. The enlarged bead 104 may facilitate mounting of a shelf 66 and may be configured to permit rotation of a shelf 66 about the enlarged bead 104 and an enlarged bead axis 120. For instance, the enlarged bead 104 may have a circular cross-section and an exterior surface 122 that may be radially disposed with respect to the enlarged bead axis 120. In such a configuration, the exterior surface 122 may extend from a first side of the stem 102 around the enlarged bead axis 120 to an opposing second side of the stem 102.

Referring primarily to FIGS. 9 and 10, one or more cassettes 62 may be movably disposed in a corresponding cassette groove 72. A cassette 62 may be slidable along the cassette groove 72 and may be connected to a panel 64. In at least one configuration, each cassette 62 may have a greater length in a direction that extends along the cassette groove 72 than the panel 64 to which it is connected, which may help support the panel 64 and inhibit rotation. A cassette 62 may have a shape or configuration that is compatible with the cassette groove 72 in which it is disposed. In at least one configuration, the cassette 62 may include a body 130 and a panel mount 132.

Referring to FIG. 10, the body 130 may be at least partially disposed in the cassette groove 72. A portion of the body 130 may be received in the cassette groove 72 with a clearance fit to facilitate movement of the cassette 62 along the cassette groove 72. In at least one configuration, the body 130 may include a first set of body grooves 134, a guide rib groove 136, or combinations thereof. In at least one configuration, the body 130 may be attached to an actuator that may facilitate actuation of the cassette 62 along the rail 60, 60′. The actuator may be of any suitable type. For instance, the actuator may be an electrical actuator, electromechanical actuator, mechanical actuator, pneumatic actuator, or the like. The actuator may be disposed inside the body 130, outside the body 130, or combinations thereof.

The first set of body grooves 134 may receive the first set of ribs 80 of the rail 60, 60′. In FIG. 10, four body grooves 134 are illustrated; however it is contemplated that a greater or lesser number of body grooves 134 may be provided. In a configuration having multiple body grooves 134, a divider rib 138 may be disposed between two adjacent body grooves 134. The divider rib 138 may be received in a gap 84 between two adjacent ribs 80 of the cassette 62.

A guide rib groove 136 may receive the guide rib 82 of the rail 60, 60′. The guide rib groove 136 may be spaced apart from the first set of body grooves 134.

The panel mount 132 may facilitate mounting of the panel 64 to the cassette 62. In at least one configuration, the panel mount 132 may be disposed outside of the cassette groove 72 and may extend away from the front face 70 of the rail 60, 60′. The panel mount 132 may include one or more arms to which the panel 64 may be fixedly attached. For instance, the panel mount 132 may include a pair of arms that may be disposed on opposite sides of the panel 64 and may cooperate to define a channel that may receive the panel 64. In at least one configuration, the panel mount 132 may have a shorter longitudinal length than the body 130.

Referring primarily to FIG. 8, one or more panels 64 may be provided with the package positioning system 26′. Each panel 64 may be mounted to at least one cassette 62. In the configuration shown, each panel 64 is mounted to two or more cassettes 62 that may be received in cassette grooves 72 of different rails. Mounting a panel 64 to two cassettes 62 may help maintain alignment and positioning of the panel 64 when the panel 64 pushes against a package 30. Moreover, mounting a panel 64 to two cassettes 62 that are each connected to an actuator may help increase the force that may be exerted by the panel 64 to push one or more packages 30. In the configuration shown, three panels 64 are illustrated; however, it is contemplated that a greater or lesser number of panels 64 may be provided. For instance, one or more additional panels 64 could be provided directly above the floor 40, directly above each shelf 66, or combinations thereof. It is also contemplated that fewer panels 64 could be provided, such as in configurations having fewer shelves 66 or rails 60, 60′. A small gap may be provided between each panel 64 and an adjacent rail 60, 60′ and between each panel 64 and a package support surface such as the floor 40 or shelf 66 that may be disposed below the panel 64 to facilitate free movement of the panel 64. Each panel 64 may have a generally flat or planar configuration and may extend in a generally perpendicular direction with respect to the longitudinal center plane 50.

Optionally, each panel 64 may include one or more openings or windows that may facilitate visibility through panel 64 as is best shown in FIG. 9. In at least one configuration, each panel 64 may have a generally rectilinear shape and may have has a diagonal brace 140 that may extend between opposing corners of the panel 64. Smaller divider braces 142 may extend from the diagonal brace 140 to help provide additional reinforcement.

The panels 64 may be independently moveable with respect to each other. For instance, the panels 64 may be independently moveable in the longitudinal direction or in a direction that extends along the longitudinal center plane 50 or substantially parallel to the longitudinal center plane 50. The distance of travel of a panel 64 in a longitudinal direction may be bounded by the bulkhead 24 and the rear wall 48 in may be further constrained by the length of the cassette groove 72.

Referring to FIG. 8, one or more shelves 66 may be provided with the package positioning system 26′. A shelf 66 may support one or more packages 30. A shelf 66 may be mounted to a rail, such as a rail 60 having a shelf groove 74. In FIG. 8, two rows of shelves 66 are shown; however, it is contemplated that a greater or lesser number of shelves may be provided. The shelves 66 may be positioned horizontally and may extend between the front and the rear of the delivery vehicle 10. A shelf 66 may be made of any suitable material, such as a metal alloy like an aluminum alloy, a polymeric material, or combinations thereof. In at least one configuration and as is best shown in FIG. 9, a shelf 66 may include a top shelf side 150, a bottom shelf side 152, a front shelf side 154, and a back shelf side 156. As is best shown in FIG. 8, a shelf 66 may also have a first shelf end 158 and the second shelf end 160.

Referring to FIG. 9, the top shelf side 150 may face away from the floor 40. One or more packages 30 may be disposed on the top shelf side 150. In at least one configuration, one or more support ribs 170 may protrude from the top shelf side 150 in a direction that extends away from the bottom shelf side 152. The support ribs 170 may be spaced apart from each other and may engage a package 30 help reduce friction between a package 30 and the shelf 66.

The bottom shelf side 152 may be disposed opposite the top shelf side 150.

The front shelf side 154 may be disposed at an end of the shelf 66 that may face away from the rail 60 to which it is mounted. In at least one configuration, the front shelf side 154 may include or may be at least partially defined by an upwardly extending lip 180 that may extend upward and away from the bottom shelf side 152. The lip 180 may protrude past the top shelf side 150 and may help hold a package 30 on the shelf 66 such that the package 30 may be inhibited from falling over the front shelf side 154, such as during transit or when a package 30 is pushed by a panel 64.

The back shelf side 156 may be disposed opposite the front shelf side 154. As such the back shelf side 156 may face toward the rail 60. The back shelf side 156 may be disposed proximate the shelf groove 74.

Referring to FIG. 8, the first shelf end 158 may extend between the front shelf side 154 and the back shelf side 156. For example, the first shelf end 158 may face toward the bulkhead 24. In at least one configuration, the first shelf end 158 may be configured as an open end that may not have a raised lip.

Referring to FIGS. 8 and 9, the second shelf end 160 may be disposed opposite the first shelf end 158. The second shelf end 160 may extend between the front shelf side 154 and the back shelf side 156. For example, the second shelf end 160 may face toward the rear wall 48. In at least one configuration, the second shelf end 160 may be configured as an open end that may not have a raised lip.

Referring to FIG. 10, the shelf 66 may be mounted to the rail 60 in any suitable manner. For instance, the shelf 66 may be mounted to the enlarged bead 104. In at least one configuration, a clip 190 may couple the shelf 66 to the enlarged bead 104. The clip 190 may be a separate component from the shelf 66 or may be integrally formed with the shelf 66. In the configuration shown, the clip 190 is provided as a separate component and extends from the shelf 66 to the enlarged bead 104. The clip 190 may be pivotable or rotatable about the enlarged bead 104 and the enlarged bead axis 120. For instance, the clip 190 may include a first curved arm 192 and a second curved arm 194 that may cooperate to partially encircle the enlarged bead 104 and retain the clip 190 on the enlarged bead 104.

The first curved arm 192 may extend along the exterior surface 122 of the enlarged bead 104 in a direction that extends toward the stem 102. A distal end of the first curved arm 192 may engage a side of the stem 102 to limit or inhibit rotation of the shelf 66 about the enlarged bead axis 120 in a first rotational direction or a clockwise direction from the perspective shown. As a result, the first curved arm 192 may help hold a shelf 66 in a generally horizontal position when the shelf 66 is in a lowered or unfolded position.

The second curved arm 194 may also extend along the exterior surface 122 of the enlarged bead 104 but may extend in the opposite direction from the first curved arm 192. The length of the second curved arm 194 may be sufficient to cooperate with the first curved arm 192 to retain the clip 190 on the enlarged bead 104. The second curved arm 194 may have a greater length than the first curved arm 192. In at least one configuration, a distal end of the second curved arm 194 may be spaced apart from the stem 102 when the shelf 66 is in the lowered or unfolded position. The distal end of the second curved arm 194 may move closer to the stem 102 when the shelf 66 is in a folded position, an example of which is shown in phantom in FIG. 10. The shelf 66 may be rotated in a counterclockwise direction about the enlarged bead axis 120 from the perspective shown to move from the unfolded position to the folded position. Optionally, a distal end of the second curved arm 194 may engage the stem 102 to limit upward movement or rotation of the shelf 66 when the shelf 66 is moved to the folded position.

Referring to FIG. 8, a panel 64 may be engageable with one or more packages 30 in the cargo area 22. For instance, a panel 64 may be configured to move and push one or more packages 30 in a predetermined direction along the floor 40 or a shelf 66. For instance, the panel 64 may be configured to move one or more packages 30 toward the front of the delivery vehicle 10 or toward the rear of the delivery vehicle 10 in a manner similar to that previously described. In the configuration shown in FIG. 8, the panels 64 are configured to move packages 30 toward the rear of the delivery vehicle 10. As such, the panel 64 may be initially positioned near the bulkhead 24 to provide space on the floor 40 and/or shelves 66 for packages 30. Packages 30 may be loaded in a predetermined arrangement that may be based on a package delivery sequence such that packages 30 are positioned rearward with respect to a corresponding panel 64. For instance, packages 30 that may be delivered first or earliest in the delivery sequence may be located furthest rearward from the panel 64 and packages 30 that may be delivered last or toward the end of the delivery sequence may be located closer to the panel 64. The panel 64 may then be moved manually or automatically in a rearward direction to push one or more packages 30 toward the rear wall 48 or toward an open rear end of a shelf 66, thereby positioning a package 30 closer to a rear door of the delivery vehicle 10 to facilitate access and reduce package retrieval time. The panel 64 may be actuated or advanced after packages 30 are delivered and space becomes available near the rear wall 48 that may allow the panel 64 to be advanced without damaging one or more packages 30. The moveable panel 28 may be actuated manually or automatically as previously discussed. Alternatively, the panels 64 may be configured to move packages 30 toward the front of the delivery vehicle 10 and toward the bulkhead 24 in a similar manner as previously discussed with respect to FIGS. 1-6.

Referring to FIG. 8, the rails 60′ that are disposed closest to the floor 40 and the roof 42 may have a single cassette groove 72. The front face 70 and the cassette groove 72 may be disposed at an angle that is offset from a vertical plane, which may also differentiate this rail 60′ from the middle rails 60 previously discussed. In such a configuration, the cassette groove 72 may be disposed closer to the center of the cargo area 22 or the longitudinal center plane 50 as compared to the cassette groove 72 of a middle rail 60. Such a configuration may allow the rails 60′ to better follow the contour of the delivery vehicle 10 and may help limit intrusion of the rails 60′ into the cargo area 22.

Components of the package positioning system 26′ may be assembled to the delivery vehicle 10 after vehicle assembly or during vehicle assembly.

As one example, the package positioning system 26′ may be installed after vehicle assembly is complete (i.e., after the original equipment manufacturer has completed vehicle assembly and associated quality checks). As such, components of the package positioning system 26′ such as the rails 60, 60′ may be mounted to the interior side of one or more walls like the first side wall 44 and the second side wall 46 after the vehicle body has been assembled and painted, and subassemblies or subsystems such as hinged closures (i.e., doors, hood, trunk lid, etc.), interior and exterior trim, drivetrain, glass, lighting, and electronics have been installed. The rails 60, 60′ may be mounted in any suitable manner, such as with one or more fasteners. Other components of the package positioning system 26′ such as cassettes 62, panels 64, and shelves 66 may be installed after the rails 60, 60′ are mounted. A panel 64 may be mounted to one or more cassettes 62 before or after a cassette 62 is installed in a cassette groove 72.

As another example, a portion of the package positioning system 26′ may be installed during the initial fabrication and assembly of the delivery vehicle 10. For instance, the rails 60, 60′ may be part of the body-in-white (BIW). Body-in-white refers to the stage of vehicle production in which the frame or body of the vehicle has been assembled or joined together (typically by welding) and prior to painting of the body and installation of hinged closures, interior and exterior trim, drivetrain, glass, lighting, and electronics. As such, the rails 60, 60′ may be structural load-bearing members of the body or may be integrally formed with the body before painting. Grooves such as the cassette groove 72, shelf groove 74, or both may be covered or masked prior to paining to inhibit primer and paint from entering a groove. After painting is complete, other components of the package positioning system 26′ such as cassettes 62, panels 64, and shelves 66 may be installed at any suitable point during vehicle assembly or after vehicle assembly is complete. Integrating the rails with the body-in-white may help reduce the overall weight and cost of the delivery vehicle as compared to configurations in which the rails are not part of the vehicle body structure and are installed after vehicle assembly is complete.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A delivery vehicle comprising:
a cargo area that is at least partially defined by a floor and a roof; and
a moveable panel that is disposed in the cargo area and that extends between the floor and the roof, wherein the moveable panel is configured to move a package in the cargo area.

2. The delivery vehicle of claim 1 wherein the moveable panel is moveable in a longitudinal direction of the delivery vehicle that extends between a front end and a rear end of the delivery vehicle.

3. The delivery vehicle of claim 1 further comprising a first side wall and a second side wall that extend from the floor to the roof and that cooperate with the floor and the roof to define the cargo area, wherein the moveable panel extends between the first side wall and the second side wall.

4. The delivery vehicle of claim 1 further comprising a second moveable panel that is disposed in the cargo area, wherein the moveable panel is moveable independently from the second moveable panel.

5. The delivery vehicle of claim 4 further comprising a first side wall and a second side wall that extend from the floor to the roof and that cooperate with the floor and roof to define the cargo area, wherein the moveable panel extends from the first side wall toward a longitudinal center plane of the delivery vehicle and the second moveable panel extends from the second side wall toward the longitudinal center plane.

6. A delivery vehicle comprising:
a cargo area that is at least partially defined by a floor, a roof, and a side wall that extends from the floor to the roof; and
first and second rails that are separated from each other and mounted to the side wall, the first and second rails each defining a cassette groove;
a first cassette that is moveably disposed in the cassette groove of the first rail;
a second cassette that is moveably disposed in the cassette groove of the second rail; and
a panel that is mounted to the first cassette and the second cassette and is engageable with a package that is disposed in the cargo area.

7. The delivery vehicle of claim 6 further comprising a shelf that is mounted to the first rail that supports the package.

8. The delivery vehicle of claim 7 wherein the shelf has a back shelf side that faces toward the first rail, a front shelf side that is disposed opposite the back shelf side, and an open end that extends between the back shelf side and the front shelf side, wherein the panel moves the package toward the open end.

9. The delivery vehicle of claim 8 wherein the front shelf side is at least partially defined by an upwardly extending lip that extends away from the floor of the delivery vehicle.

10. The delivery vehicle of claim 7 wherein the first rail defines a shelf groove, and a shelf mounting protrusion is disposed in the shelf groove to which the shelf is mounted.

11. The delivery vehicle of claim 10 wherein the shelf mounting protrusion includes a stem that extends from the first rail and an enlarged bead that extends from the stem, wherein the shelf is mounted to the enlarged bead.

12. The delivery vehicle of claim 11 wherein the shelf is pivotable about the enlarged bead.

13. The delivery vehicle of claim 10 wherein the first rail includes a second cassette groove and wherein the shelf groove is positioned between the cassette groove of the first rail and the second cassette groove.

14. The delivery vehicle of claim 10 wherein the cassette groove includes a first set of ribs that are spaced apart from each other and that extend toward the shelf groove, wherein members of the first set of ribs are received in corresponding body grooves of the first cassette.

15. The delivery vehicle of claim 14 wherein the cassette groove includes at least one guide rib that is disposed opposite the first set of ribs and that extends toward the first set of ribs, wherein the guide rib is received in a guide rib groove of the first cassette.

16. The delivery vehicle of claim 6 wherein the second rail has a single cassette groove.

17. The delivery vehicle of claim 16 wherein the single cassette groove of the second rail is disposed closer to a longitudinal center plane of the delivery vehicle than the cassette groove of the first rail is disposed to the longitudinal center plane.

18. A method of assembling a delivery vehicle comprising:
providing a body-in-white vehicle body that a floor, a roof, and a side wall that is joined to the floor and the roof; and
providing first and second rails that are part of the side wall of the body-in-white, the first and second rails are separated from each other and each defining a cassette groove.

19. The method of claim 18 wherein the body-in-white vehicle body is painted after the first and second rails are mounted to the side wall.

20. The method of claim 19 further comprising inserting a first cassette into the cassette groove of the first rail such that the first cassette that is moveably disposed in the cassette groove of the first rail, inserting a second cassette into the cassette groove of the second rail such that the second cassette that is moveably disposed in the cassette groove of the second rail, and mounting a panel to the first cassette and the second cassette after the body-in-white vehicle body is painted.
